(19) United States
(12) Patent Application Publication
(10) Pub. No.: US 2024/0179426 A1
(43) Pub. Date: May 30, 2024

(54) RADIATION IMAGE APPARATUS WITHOUT SYNCHRONOUS COMMUNICATION

(71) Applicant: CANON KABUSHIKI KAISHA, Tokyo (JP)

(72) Inventor: YOHEI KOIKE, Kanagawa (JP)

(21) Appl. No.: 18/516,506

(22) Filed: Nov. 21, 2023

(30) Foreign Application Priority Data
Nov. 28, 2022 (JP) 2022-188825

(51) Int. Cl. H04N 25/30

(52) U.S. Cl. CPC H04N 25/30; G01N 23/043

(57) ABSTRACT

A radiation image apparatus without synchronous communication includes a pixel circuit, a reading circuit, a drive control circuit, an image processing circuit, a time measuring circuit, and a management circuit. The pixel circuit includes an imaging element configured to generate image data based on radiation and a detecting element configured to generate irradiation data of irradiation with the radiation. The reading circuit is configured to read the image data and the irradiation data. The drive control circuit is configured to control a first time when the image data is read by the reading circuit. The image processing circuit is configured to perform correction of the read image data. The time measuring circuit is configured to measure a second time related to the irradiation with the radiation based on the irradiation data. The management circuit is configured to manage the correction based on the first time and the second time.

### BACKGROUND

### Technical Field

One disclosed aspect of the embodiments relates to a radiation image apparatus that performs fluoroscopy without synchronous communication with a radiation generating apparatus.

### Description of the Related Art

An apparatus that captures a still image without synchronous communication with a radiation generating apparatus is present. A user can perform image capturing without being restricted by a cable length. Meanwhile, a connection using a synchronous communication cable for a moving image is complex and reduces the flexibility of system upgrades in a moving image instrument carriage and the like.

Japanese Patent Laid-Open No. 2022-107783 describes a technique in which moving-image capturing is performed while a radiation generating apparatus and a radiation image apparatus are synchronized with each other via wireless communication. Japanese Patent Laid-Open No. 2022-107783 also describes a synchronization correction method that is performed when the radiation generating apparatus and the radiation image apparatus are out of synchronization with each other during moving-image capturing.

However, in the method disclosed in Japanese Patent Laid-Open No. 2022-107783, it is necessary to constantly check whether the radiation generating apparatus and the radiation image apparatus are out of synchronization with each other and correct the synchronization when the apparatuses are out of synchronization with each other.

### SUMMARY OF THE INVENTION

One embodiment of the disclosure provides a technique for implementing moving-image capturing by pulse fluoroscopy without performing synchronous communication with a radiation generating apparatus and performing complex synchronous error correction.

In view of the problems described above, according to an aspect of the disclosure, a radiation image apparatus without synchronous communication includes a pixel circuit. a reading circuit, a drive control circuit, an image processing circuit, a time measuring circuit, and a management circuit. The pixel circuit includes an imaging element configured to generate image data based on radiation and a detecting element configured to generate irradiation data of irradiation with the radiation. The reading circuit is configured to read the image data and the irradiation data. The drive control circuit is configured to control a first time when the image data is read by the reading circuit. The image processing circuit is configured to perform correction of the read image data. The time measuring circuit is configured to measure a second time related to the irradiation with the radiation based on the irradiation data. The management circuit is configured to manage the correction based on the first time and the second time.

Further features of the disclosure will become apparent from the following description of exemplary embodiments with reference to the attached drawings.

### BRIEF DESCRIPTION OF THE DRAWINGS

FIG. 1 is a block diagram illustrating an example of a configuration of a radiation imaging system according to a first embodiment.

FIG. 2 is a block diagram illustrating an example of a configuration of a radiation detecting unit or circuit of the radiation imaging system illustrated in FIG. 1.

FIG. 3 is a flowchart for frames from a first frame to a second frame according to the first embodiment.

FIG. 4 is a timing chart for the frames from the first frame to the second frame according to the first embodiment.

FIG. 5 is another timing chart for the frames from the first frame to the second frame according to the first embodiment.

FIG. 6 is a timing chart for frames from a first frame to a second frame according to a second embodiment.

FIG. 7 is a flowchart for the frames from the first frame to the second frame according to the second embodiment.

### DESCRIPTION OF THE EMBODIMENTS

### First Embodiment

Embodiments of the disclosure are described with reference to the accompanying drawings.

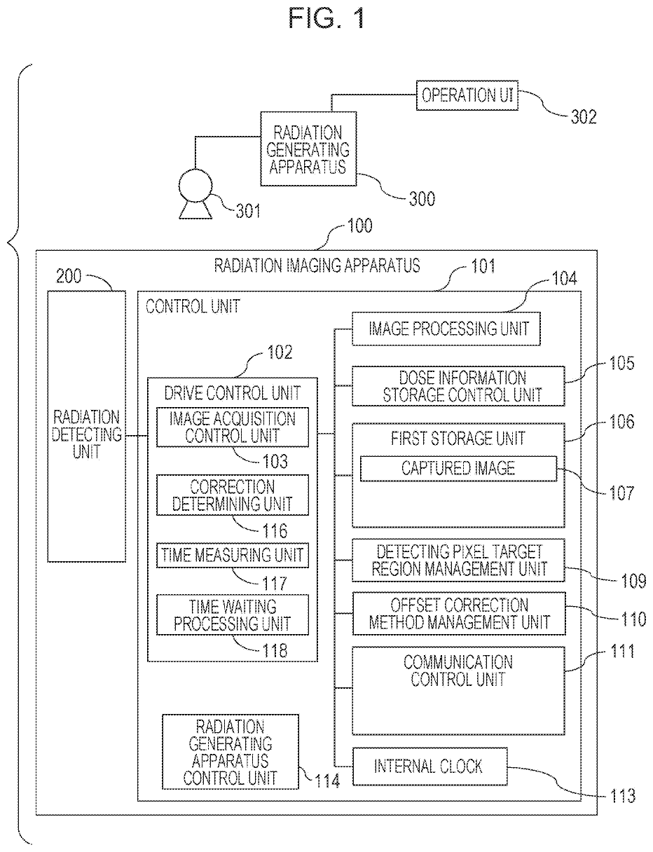

FIG. 1 illustrates an example of a configuration of a radiation imaging system. The radiation imaging system includes a radiation image apparatus 100 including a radiation detecting unit or circuit 200, a radiation source 301 that emits radiation, and a radiation generating apparatus 300 that controls the radiation source 301.

The radiation image apparatus 100 includes the radiation detecting unit or circuit 200 that detects radiation and generates image data based on the detected radiation, and a control unit or circuit 101 that controls image capturing and a communication operation. The control unit or circuit 101 includes a drive control unit or circuit 102 that controls driving of the radiation detecting unit or circuit 200 and acquisition of a radiographic image and an offset image, and an image processing unit or circuit 104 that performs image processing such as offset correction, gain correction, and defective pixel correction on an image acquired from the radiation detecting unit or circuit 200. The control unit or circuit 101 further includes a dose information storage control unit or circuit 105 that controls storage of dose information according to image capturing, a first storage unit or circuit 106 that stores the acquired image data and the dose information and is a volatile memory, and a communication control unit or circuit 111 that controls communication with a control apparatus 400 and communication with the radiation generating apparatus 300. The control unit or circuit 101 further includes an internal clock 113 that acquires an image capturing time, an elapsed time, and the like, a radiation generating apparatus control unit or circuit 114 that controls an irradiation time point based on a radiation emission signal for emission of radiation by the radiation generating apparatus 300, and a correction determining unit or circuit 116 that determines an offset correction method. The control unit or circuit 101 further includes a time measuring unit or circuit 117 that measures an interval between times when irradiation with radiation is detected, a time waiting processing unit or circuit 118 that causes processing to wait for a predetermined period, and a detecting pixel target region management unit or circuit 109 that manages a target region in which a detecting pixel 204 described later is read. The control unit or circuit 101 further includes an offset correction method management unit or circuit 110 that specifies an offset correction method according to a user's request. Although the time measuring unit or circuit 117 is described later in detail, the time measuring unit or circuit 117 is used to measure (perform time measurement) an interval between times when the radiation image apparatus 100 is irradiated with radiation, and irradiation times. Since the time measuring unit or circuit 117 is used to manage correction (described later) using the results of the time measurement together with the offset correction method management unit or circuit 110, the time measuring unit or circuit 117 forms a part of a management unit or circuit, which is described later.

The control unit or circuit 101 controls the overall radiation image apparatus 100. Alternatively, the control unit or circuit 101 may control the radiation image apparatus 100 by using a control signal generating circuit such as an ASIC. The control of the radiation image apparatus 100 may be implemented by both a program and a control circuit.

The radiation generating apparatus 300 includes an operation user interface (UI) 302 for operating the radiation generating apparatus 300. The operation UI 302 is used to set a condition for irradiation with radiation and to emit radiation. In a conventional technique, synchronizing signals that are, for example, notifications of the start and completion of irradiation with radiation, a notification indicating a point of time when irradiation with radiation can be performed, and the like are exchanged between a radiation generating apparatus and a radiation image apparatus via a wired connection. However, in the present embodiment, the radiation generating apparatus 300 and the radiation image apparatus 100 are not connected to each other.

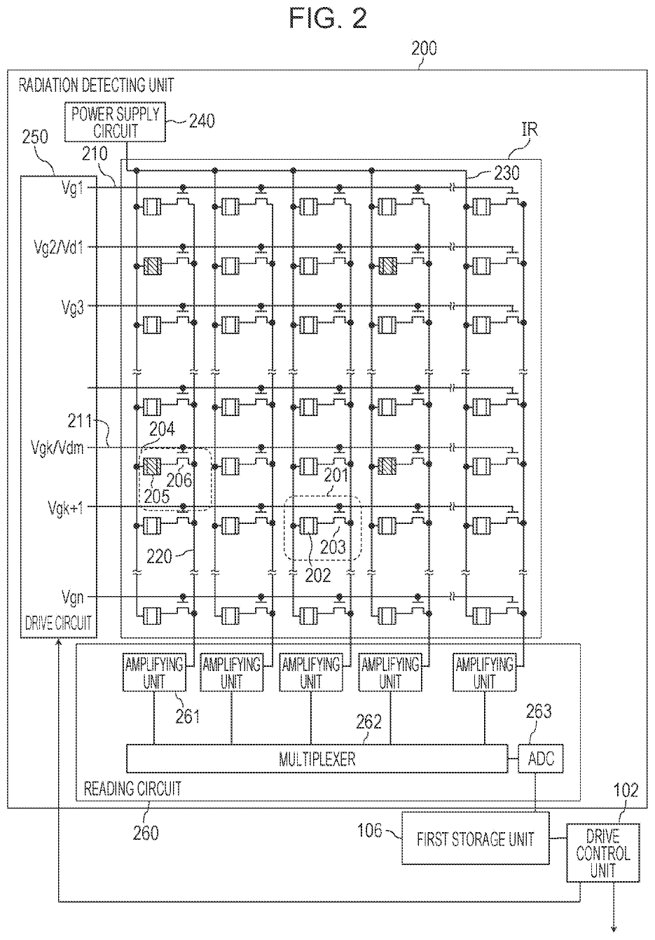

FIG. 2 illustrates an example of a configuration of the radiation detecting unit or circuit 200. The radiation detecting unit or circuit 200 includes a plurality of pixels arrayed in an imaging region IR and forming a plurality of rows and a plurality of columns, a plurality of drive lines 210, and a plurality of signal lines 220. The plurality of drive lines 210 is disposed corresponding to the plurality of rows of the pixels. Each of the drive lines 210 corresponds to a respective one of the rows of the pixels. The plurality of signal lines 220 is disposed corresponding to the plurality of columns of the pixels. Each of the signal lines 220 corresponds to a respective one of the columns of the pixels.

The plurality of pixels includes a plurality of imaging pixels 201 that can generate radiographic image data, and one or more detecting pixels 204 that can generate irradiation data of irradiation with radiation. It suffices for one or more detecting pixels 204 to be provided in the radiation detecting unit or circuit 200, but a plurality of detecting pixels 204 can be provided in the radiation detecting unit or circuit 200.

Each of the imaging pixels 201 includes a conversion element or circuit 202 that converts radiation into an electrical signal, and a switch element or circuit 203 connecting the conversion element or circuit 202 and a signal line 220 corresponding to the imaging pixel 201 to each other. The detecting pixel 204 includes a conversion element or circuit 205 that converts radiation into an electrical signal, and a switch element or circuit 206 connecting the conversion element or circuit 205 and a signal line 220 corresponding to the detecting pixel 204 to each other. The detecting pixel 204 is included in a row and a column formed by a plurality of imaging pixels 201. Hereinafter, the conversion elements or circuits 202 of the imaging pixels 201 may be referred to as imaging elements or circuits, and the conversion element or circuit 205 of the detecting pixel 204 may be referred to as a detecting element or circuit in order to distinguish the conversion elements or circuits 202 from the conversion element or circuit 205. The imaging elements or circuits 201 and the detecting pixel 204 disposed in the imaging region IR may be collectively merely referred to as a pixel unit or circuit. In FIG. 2, the imaging pixels 201 are distinguished from the detecting pixel 204 by depicting the conversion element or circuit 205 by hatching in a different manner from the conversion elements or circuits 202.

Each of the conversion elements or circuits 202 and the conversion element or circuit 205 may include a scintillator that converts radiation into light, and a photoelectric conversion element or circuit that converts the light into an electrical signal. In general, the scintillator is formed in a sheet shape so as to cover the imaging region IR and is shared by the plurality of pixels. Instead of this, each of the conversion elements or circuits 202 and the conversion element or circuit 205 may directly convert radiation into an electrical signal.

Each of the switch elements or circuits 203 and the switch element or circuit 206 may include, for example, a thin film transistor (TFT) having an active region formed of a semiconductor such as amorphous silicon or polycrystalline silicon.

The detecting pixel 204 has a similar pixel configuration to those of the imaging pixels 201 and is connected to a drive line 210 corresponding to the detecting pixel 204 and the signal line 220 corresponding to the detecting pixel 204. The imaging pixels 201 may be connected to the signal line 220 to which the detecting pixel 204 is connected.

A drive circuit 250 is configured to supply a drive signal to the pixels to be driven through the plurality of drive lines 210 in accordance with a control signal from the drive control unit or circuit 102. By the supply of the drive signal to the pixels, signals accumulated in the conversion elements or circuits of the pixels become readable by a reading circuit 260. In a case where a drive line 210 is connected to at least one detecting pixel 204, the drive line 210 is referred to as a detection drive line 211.

The reading circuit 260 is configured to read signals from the plurality of pixels through the plurality of signal lines 220. The reading circuit 260 includes a plurality of amplifying units or circuits 261, a multiplexer 262, and an analog-to-digital converter (hereinafter referred to as an AD converter) 263. Each of the signal lines 220 is connected to a corresponding amplifying unit or circuit 261 among the amplifying units or circuits 261 of the reading circuit 260. Each of the signal lines 220 corresponds to a respective one of the amplifying units or circuits 261. The multiplexer 262 selects the plurality of amplifying units or circuits 261 in predetermined order and supplies signals from the selected amplifying units or circuits 261 to the AD converter 263. The AD converter 263 converts the supplied signals into digital signals. Image data having digital values obtained by converting the supplied signals into the digital signals is stored in the first storage unit or circuit 106 illustrated in FIG. 1.

The drive control unit or circuit 102 includes an image acquisition control unit or circuit 103 that controls acquisition of images such as a radiographic image obtained by irradiation with radiation and an offset image obtained without irradiation with radiation. The image acquisition control unit or circuit 103 causes the radiation image apparatus 100 to be irradiated with radiation during accumulation of image data in each of the pixels, reads the image data from the pixels, and causes the image data as a captured image 107 that is a radiographic image to be held in the first storage unit or circuit 106. By continuously performing this operation, it is possible to capture a moving image. In addition, while driving is performed in a similar manner to the radiographic image acquisition, image data read in a state in which the radiation image apparatus 100 is not irradiated with radiation can be held as an offset image in the first storage unit or circuit 106.

The acquired radiographic image is subjected to correction such as offset correction, gain correction, and defective pixel correction by the image processing unit or circuit 104 and transferred to an image control apparatus (not illustrated) via the communication control unit or circuit 111. The correction may not be performed in the radiation image apparatus 100. For example, the radiation image apparatus 100 may transfer the acquired radiographic image and the offset image to the image control apparatus 500 without correcting the radiographic image and the offset image, and the image control apparatus 500 may perform the correction of the radiographic image. The above-described process is a process from the emission of radiation from the radiation generating apparatus 300 to the radiation image apparatus 100 through the conversion of the radiation into electric charges to the generation of a single still image. Meanwhile, when the radiation image apparatus 100 is irradiated with radiation at a point of time when the radiation image apparatus 100 cannot acquire an image in moving-image capturing, the radiation causes invalid exposure and becomes harmful. Therefore, it is possible to capture a moving image by periodically and alternately repeating irradiation with radiation and reading of electric charges. In the moving-image capturing, it is necessary to perform irradiation with radiation and reading of electric charges for a single frame, periodically perform frame processing during irradiation with radiation, and start and stop a series of operations of alternately performing irradiation with radiation and reading electric charges. In the present embodiment, points of time when the irradiation and the reading are alternately performed correspond to a frame rate, and the adjustment of a period of accumulation of electric charges and a period of reading by a sensor results in the adjustment of a frame rate of a moving image.

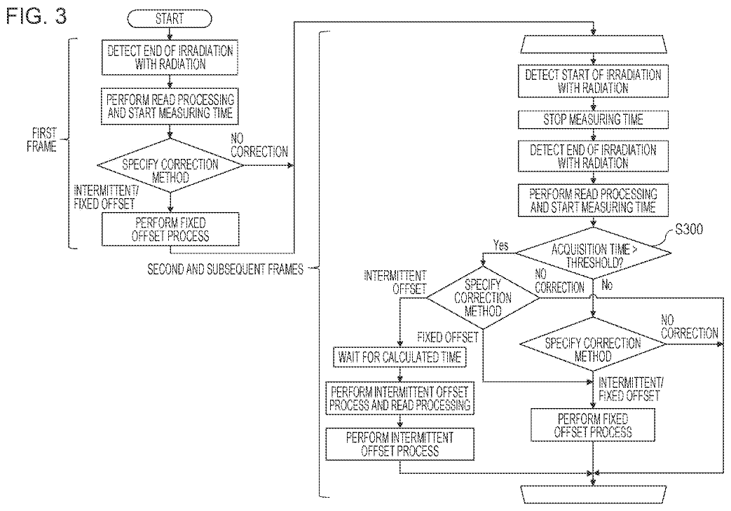

In the present embodiment, a fluoroscopy method of the radiation generating apparatus 300 and the radiation image apparatus 100 in the above-described state is described with reference to FIG. 3.

When the radiation generating apparatus 300 emits radiation, an operation of reading a pixel value is performed on the detecting pixel 204 in real time at fixed intervals during the emission of the radiation. Electric charges are accumulated in the detecting pixel 204, a total pixel value of the detecting pixel 204 as a target is calculated using a pixel value converted by the AD converter 263 and is compared with a threshold calculated according to a predetermined calculation method. When the total pixel value exceeds the threshold, it is detected that the radiation image apparatus 100 was irradiated with the radiation. In addition, the irradiation with the radiation is stopped, the pixel value converted by the AD converter 263 becomes equal to or lower than the fixed threshold, and the stop of the irradiation with the radiation is detected. By constantly performing this process in real time, the detection of the start and end of irradiation with radiation is implemented. After the end of the irradiation with the radiation is detected, the image acquisition control unit or circuit 103 reads the imaging pixels 201 according to the above-described method to acquire an image. In parallel with the start of the image reading, the time measuring unit or circuit 117 starts measuring time. After the image is acquired, correction is performed according to a correction method specified by the offset correction method management unit or circuit 110 illustrated in FIG. 1. Since offset correction is only a fixed offset process for the first frame, even when an intermittent offset process is specified, the fixed offset process is performed for the first frame. The fixed offset process is a method of correcting signals read from the imaging pixels 201 by using a correction value (offset correction value). The intermittent offset process is a method of correcting signals read from the imaging pixels 201 by using a newly obtained correction value (hereinafter referred to as a dark current image) obtained by performing an accumulating operation and a read operation on the imaging pixels 201 in a state in which the radiation image apparatus 100 is not irradiated with radiation, immediately after the reading of the signals from the imaging pixels 201. The fixed offset process is performed using an offset image stored in advance in the first storage unit or circuit 106. In a case where no correction is specified according to a user's request, the offset correction is not performed.

In order to improve the accuracy of detecting irradiation with radiation, all the detecting pixels 204 included in the radiation detecting unit or circuit 200 may be used as a target region in which irradiation with radiation is to be detected according to a user's request. In addition, a partial region specified by the detecting pixel target region management unit or circuit 109 illustrated in FIG. 1 and a plurality of partial regions may be used. Furthermore, in the predetermined calculation method, in a case where the plurality of partial regions is specified by the detecting pixel target region management unit or circuit 109, a total value, an average value, a maximum value, or a minimum value of values of electric charges in each of the regions, and a combination of the total value, the average value, the maximum value, and the minimum value of values of electric charges in each of the regions may be used.

Next, the detection of the start of irradiation with radiation for the second frame is performed by the detecting pixel 204 in a similar manner to the detection process performed for the first frame. At a point of time when the start of irradiation with radiation is detected, the measurement by the time measuring unit or circuit 117 is stopped. A time measured by the time measuring unit or circuit 117 is hereinafter referred to as an acquisition time. In processing of detecting the stop of the irradiation with the radiation and read processing after the acquisition time, processing similar to the processing performed for the first frame is performed. The offset processing method is determined based on the time acquired by the time measuring unit or circuit 117. In the present embodiment, the determination is performed based on a magnitude relationship with a threshold.

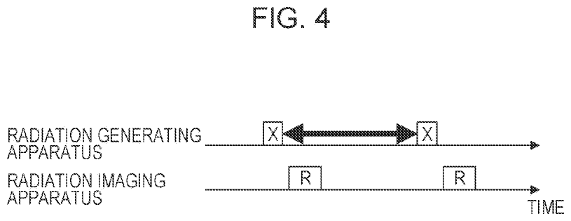

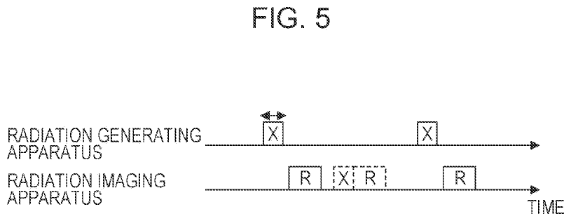

The irradiation with radiation and the read processing illustrated in the flowchart of FIG. 3 are described with reference to FIG. 4 from the viewpoint of points of time when processing is performed in the radiation generating apparatus 300 and the radiation image apparatus 100. In this case, “X” represents that radiation is being emitted by the radiation generating apparatus 300, and “R” represents processing of reading the pixels. A period of time measured by the time measuring unit or circuit 117 described above corresponds to a double-headed arrow illustrated in FIG. 4. It is possible to determine whether it is possible to execute intermittent offset process in which correction is performed by reading the pixels again before the start of irradiation with radiation for a next frame based on a result of the period measured by the time measuring unit or circuit 117 and acquiring a dark current image as an offset image. In this case, a threshold as a determination criterion may be a value obtained by adding a certain period of time to two reading periods for which the measured period is known. In addition, to perform the intermittent offset process, at least a period corresponding to two reading periods and a single irradiation period for irradiation with radiation is required. Therefore, as illustrated in FIG. 5, a period from the start of irradiation with radiation for the first frame to the stop of the irradiation with the radiation for the first frame is and measured by the time measuring unit or circuit 117 and represented by a double-headed arrow. A period obtained by summing the reading periods, a period corresponding to the single irradiation period, and a period for reading the dark current image may be used as a calculation equation for the threshold. The period corresponding to the single irradiation period is represented by a broken line X illustrated in FIG. 5. The period for reading the dark current image is represented by a broken line R illustrated in FIG. 5. Even in a case where the intermittent offset process can be performed, the fixed offset process may be desirable depending on a fluoroscopy environment and a user's request. Therefore, the determination may be made based on not only the comparison with the threshold and a condition such as an image capturing environment.

A process of determining an offset process in S300 and the subsequent steps by the time measuring unit or circuit 117 illustrated in FIG. 3 is described below.

When the acquisition period (from the end of irradiation with radiation to the start of the next irradiation with radiation) is equal to or shorter than a threshold, the intermittent offset process cannot be performed. Therefore, in a case where the intermittent offset process and the fixed offset process are specified by the offset correction method management unit or circuit 110, the fixed offset process is performed. In the fixed offset process, the same processing as that for the first frame is performed. In a case where no correction is specified by the offset correction method management unit or circuit 110, the fixed offset process is not performed.

When the acquisition time exceeds the threshold, the intermittent offset process can be performed and the correction is appropriately performed according to a correction method specified by the offset correction method management unit or circuit 110. In a case where the fixed offset process is specified or no correction is specified, the same processing as described above is performed. Therefore, a case where the intermittent offset process is specified is described below. To generate an offset correction image, the intermittent offset process is performed by performing reading processing after the time waiting processing unit or circuit 118 causes the reading processing to wait for a predetermined time after processing of reading image data. In this case, the predetermined time for which the time waiting processing unit or circuit 118 causes the reading processing to wait can be set to be equal to a period for which the radiation image apparatus 100 is irradiated with radiation. As described above, a correction method to be performed is managed and executed based on a correction method specified by the offset correction method management unit or circuit 110 and a result of measuring a time by the time measuring unit or circuit 117. After that, by performing similar processing, the fluoroscopy processing can be continuously performed without a synchronization error.

As the waiting time for which the time waiting processing unit or circuit 118 causes the reading processing to wait, a measurement period measured by the time measuring unit or circuit 117 may be used. Alternatively, the predetermined time for which the time waiting processing unit or circuit 118 causes the reading processing to wait may be calculated using the reading periods and the period corresponding to the single irradiation period for the irradiation with the radiation as described above.

Therefore, fluoroscopic imaging can be continuously performed without a synchronization error by detecting irradiation with radiation using the detecting pixel and performing reading after the detection. In addition, it is possible to provide a fluoroscopy apparatus that dynamically performs the correction according to a frame rate and thus does not perform synchronous communication.

### Second Embodiment

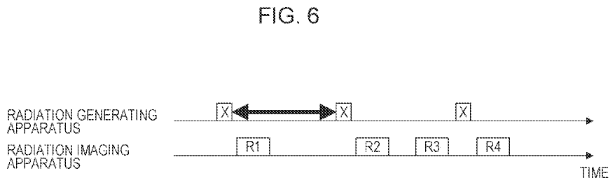

A second embodiment is described below with reference to FIG. 6. In a case where an image is captured during fluoroscopy, it is important to immediately display the image. In the first embodiment, the intermittent offset image acquisition processing is performed after the acquisition of a radiographic image. However, in the second embodiment, since intermittent offset image acquisition processing is performed before acquisition of a radiographic image, the radiographic image can be displayed immediately after the acquisition of the radiographic image. That is, processing of correcting read image data is performed using intermittent offset data acquired before the reading of the image data, or using intermittent offset data acquired immediately before the reading of the image data, and thus the radiographic image can be immediately displayed. This feature is described below.

Processing up to reading processing R1 and R2 for a second frame is the same as that described in the first embodiment, but the second embodiment is different from the first embodiment in that an intermittent offset processed image is generated before processing of reading a target in the second embodiment. Reading processing R3 after the reading processing R2 is performed on an offset processed image not for an image generated in the reading processing R2 but for an image generated in reading processing R4. Similar processing is performed for the third frame and the subsequent frames.

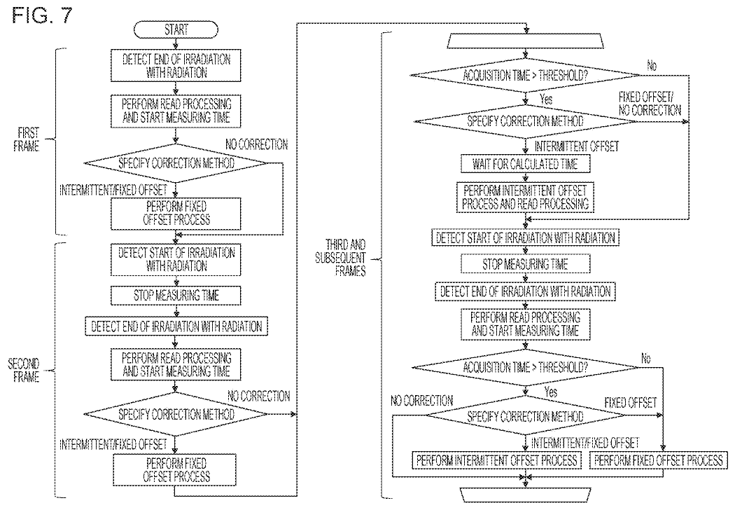

Processing according to the present embodiment is described with reference to FIG. 7. The processing up to the reading processing for the second frame is similar to that described in the first embodiment. A fixed offset process is performed for the second frame, unlike the first embodiment. Next, it is determined whether an intermittent offset process can be performed according to a measured period in a similar manner to the first embodiment. However, since the fixed offset process has been already performed for the second frame, no processing is performed when the measured period is equal to or shorter than a threshold. When the measured period exceeds the threshold, processing up to acquisition of an intermittent offset image is performed, but offset correction itself is not performed. Then, in processing from the detection of the start of irradiation with radiation to reading processing and processing of starting measuring time, similar processing to that described in the first embodiment is performed. Thereafter, the fixed offset process or the intermittent offset process is performed based on comparison of an acquisition time with a threshold again. Thus, the acquisition of an intermittent offset image is continuously performed before acquisition of a radiographic image, and the image can be immediately displayed earlier by a time required for acquiring an intermittent offset image at the time of the stop of the irradiation with the radiation than the first embodiment.

According to the disclosure, moving-image capturing by pulse fluoroscopy can be implemented without performing synchronous communication with the radiation generating apparatus and complex synchronous error correction.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-188825, filed Nov. 28, 2022, which is hereby incorporated by reference herein in its entirety.

What is claimed is:

1. A radiation image apparatus without synchronous communication, comprising:
a pixel circuit including an imaging element configured to generate image data based on radiation and a detecting element configured to generate irradiation data of irradiation with the radiation;
a reading circuit configured to read the image data and the irradiation data;
a drive control circuit configured to control a first time when the image data is read by the reading circuit;
an image processing circuit configured to perform correction of the read image data;
a time measuring circuit configured to measure a second time related to the irradiation with the radiation based on the irradiation data; and
a management circuit configured to manage the correction based on the first time and the second time.

2. The radiation image apparatus according to claim 1,
wherein the correction is offset correction.

3. The radiation image apparatus according to claim 2,
wherein the correction is a fixed offset process or an intermittent offset process.

4. The radiation image apparatus according to claim 1,
wherein the pixel circuit includes a plurality of detecting elements identical to the detecting element and a selecting circuit configured to select, from among the plurality of detecting elements, a detecting element from which the irradiation data is read by the reading circuit.

5. The radiation image apparatus according to claim 4,
wherein the time measuring circuit measures a time related to the irradiation with the radiation based on any one of an average value, a maximum value, and a minimum value of irradiation data of the plurality of detecting elements.

6. The radiation image apparatus according to claim 3,
wherein the correction is the intermittent offset process, and the drive control circuit includes a time waiting processing circuit configured to cause an operation of reading the image data by the reading circuit to wait for a predetermined time.

7. The radiation image apparatus according to claim 1, further comprising
a method management circuit configured to receive specifying of the correction by a user.

8. The radiation image apparatus according to claim 3,
wherein the correction is the intermittent offset process, and the image processing circuit uses intermittent offset data acquired before the reading of the image data to correct the image data read by the reading circuit.
